(19) United States
(12) Patent Application Publication
(10) Pub. No.: US 2009/0275725 A1
(43) Pub. Date: Nov. 5, 2009

(54) POLYSULPHONES AND POLYETHER SULPHONES WITH REDUCED YELLOW INDEX AND PROCESSES FOR THEIR PREPARATION

(75) Inventors: Christian Dienes, Landau (DE); Marco Krüger, Mannheim (DE); Stefan Müssig, Mannheim (DE); Jörg Erbes, Karlsruhe (DE); Achim Stammer, Freinsheim (DE); Martin Weber, Maikammer (DE); Karl-Heinz Wassmer, Mutterstadt (DE); Gerhard Lange, Schriesheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/306,152

(22) PCT Filed: Jun. 13, 2007
(86) PCT No.: PCT/EP2007/055797

§ 371 Date: Dec. 22, 2008

(30) Foreign Application Priority Data
Jun. 22, 2006 (EP) 06115900.0

(51) Int. Cl. C08G 75/20; C08G 75/23

(52) U.S. Cl. 528/391

(57) ABSTRACT

The present invention relates to a process for the preparation of polysulfones having a yellowness index according to DIN 6167 of less than 19 and polyether sulfones having a yellowness index according to DIN 6167 of less than 30, wherein the polymerization is carried out in basic, aprotic solvents with the use of a positively conveying stirrer passing close to the wall. The present invention also relates to the polyether sulfones and polysulfones obtainable for the first time by this process and to the use of such polymers for the production of moldings, films, membranes and foams.

The present invention relates to a process for the preparation of polysulfones having a yellowness index according to DIN 6167 of less than 19 and polyether sulfones having a yellowness index according to DIN 6167 of less than 30.

The present invention also relates to the polyether sulfones and polysulfones obtainable for the first time by this process and to the use of such polymers for the production of moldings, films, membranes and foams.

Polyether sulfones and polysulfones belong to the group consisting of the high-performance thermoplastics and are distinguished by high heat distortion resistance, good mechanical properties and inherent flame retardance (E. M. Koch, H.-M. Walter, Kunststoffe 80 (1990) 1146; E. Döring, Kunststoffe 80, (1990) 1149). Owing to their good biocompatibility, polyether sulfones and polysulfones are also used as material for the production of dialysis membranes (S. Savariar, G. S. Underwood, E. M. Dickinson, P. J. Schielke, A. S. Hay, Desalination 144 (2002) 15).

The preparation of the polyether sulfones and polysulfones is usually effected by polycondensation of suitable monomer building blocks in dipolar aprotic solvents at elevated temperature (R. N. Johnson et al., J. Polym. Sci. A-1 5 (1967) 2375, J. E. McGrath et al., Polymer 25 (1984) 1827).

The preparation of polyarylene ether sulfones from suitable aromatic bishalosulfones and aromatic bisphenols or salts thereof in the presence of at least one alkali metal or ammonium carbonate or bicarbonate in an aprotic solvent are described, for example, in U.S. Pat. No. 4,870,153, EP 113 112, EP-A 297 363 and EP-A 135 130.

All these preparation processes described in the literature give polyether sulfones and polysulfones which are not completely satisfactory with regard to their optical properties. Thus, the processes known from the literature lead to products having an unsatisfactorily high yellowness index of more than 30 according to DIN 6167. Furthermore, the products known from the literature have a transmittance, measured according to ASTM D 1003, of less than 85% and a haze, measured by the same method, of substantially above 3%.

It was accordingly the object of the present invention to provide a process for the preparation of improved polyether sulfones and polysulfones which do not have the abovementioned disadvantages.

Surprisingly, the object was achieved by carrying out the polymerization in basic, aprotic solvents with the use of a positively conveying stirrer passing close to the wall.

The polymerization in the presence of, if appropriate, an alkali metal or ammonium carbonate or bicarbonate and in an aprotic solvent is described in detail, for example, in U.S. Pat. No. 4,870,153, EP 113 112, EP-A 297 363, EP 347 669 and EP-A 135 130, which are expressly incorporated by reference at this point. In particular these documents describe, for example, suitable starting materials, catalysts and solvents, suitable ratios of the substances participating and suitable reaction times and reaction parameters, such as reaction temperatures or reaction pressures, and suitable working-up methods. In general, crossbeam stirrers or propeller stirrers having flow breakers, which do not pass close to the wall and are not positively conveying, are used as stirrers during the polymerization in the abovementioned references. At most, anchor stirrers passing close to the wall, as described, for example, in EP 937749, are used in some cases in the working-up of polymerization materials.

In the process according to the invention, positively conveying stirrers passing close to the wall are also used during the polymerization. Positively conveying stirrers passing close to the wall may be, for example, anchor stirrers, which are preferably crossed, i.e. have set stirrer blades. For example, the helical stirrers described by M. Zlokarnik in Rührtechnik-Theorie und Praxis, 1999, page 6, can be used. Use of so-called Seba stirrers or Paravisc stirrers from Ekato—as described, for example, in DE 4219 733, G 9208095.2, G 9208094.4 and G 9208096.0 and Handbuch der Rührtechnik, 2nd edition 2000, page 85—is particularly preferred. Positively conveying stirrers with d/D>0.9 are preferably used.

The use of positively conveying stirrers passing close to the wall in the process according to the invention leads not only to the described improvement in the properties of the polyether sulfones and polysulfones. A further advantage of the process according to the invention is based on the shortening of the reaction time and the possibility of carrying out the reaction in more concentrated form. The process according to the invention is distinguished by high process economy and process capability.

### EXAMPLES

a) Preparation of the Polysulfone or Polyether Sulfone

The dried monomers, 1) dichlorodiphenyl sulfone and bisphenol A or 2) dichlorodiphenyl sulfone and dihydroxydiphenyl sulfone, were initially taken in equimolar amounts, together with dried potassium carbonate under a nitrogen atmosphere in a 4 l reactor having an internal thermometer, gas inlet tube and reflux condenser with water separator, dissolved in N-methylpyrrolidone (NMP) with stirring and heated to 190° C. The water of reaction was distilled off and the level was kept constant by adding NMP during the reaction. The reaction was stopped by dilution with cold NMP, after which methyl chloride (10 l/h) was passed (45 minutes) into the batch at 140° C. for 45 minutes. Thereafter, nitrogen was passed in (20 l/h) and the batch was cooled. The potassium chloride formed was filtered off and the polymer solution was precipitated in water. The polymer viscosity was assessed with the viscosity number (VN:ml/g). The viscosity number of the polyether sulfones and polysulfones was determined in 1% strength solution in NMP at 25° C.

b) Production and Optical Properties of the Moldings

For assessing the optical properties of the products, injection molded test specimens (round disks, diameter 60 mm, thickness 2 mm) were produced at a melt temperature of 310° C. (for PSU) or 350° C. (for PES) and a mold temperature of 140° C. The measurement of the transmittance and haze was effected according to ASTM D 1003, and the intrinsic color of the products was determined on the basis of the yellowness index (YI) according to DIN 6167.

The results of the tests relating to polysulfone PSU are shown in table 1. The results of the tests relating to polyether sulfone PES are shown in table 2.

TABLE 1
PSU polymerization experiments with different stirrers

| Experiment | 1 | 2 | C3 | C4 |
|---|---|---|---|---|
| Stirrer: | crossed anchor | Paravisc** | crossbeam/ | propeller |
| | stirrer | | flow breaker | stirrer |
| SC* | 60% | 60% | 60% | 60% |
| Determination | 5 | 5 | 5 | 9 |
| time (hours) | | | | |
| VN [ml/g] | 62 | 63 | 59 | 63 |
| Transmittance | 89 | 88 | 86 | 84 |
| [%] | | | | |
| Haze [%] | 1.5 | 1.5 | 3 | 4.5 |
| YI | 14 | 13 | 19 | 26 |

*The solids content (SC) is defined as the mass of the solids (monomers and potassium carbonate) relative to the mass of the total batch.
**Paravisc stirrer, Ekato, Handbuch der Rührtechnik, 2nd edition 2000, page 85. Paravisc and crossed anchor stirrer are positively conveying stirrers passing close to the wall (cf. examples 1 and 2) and the others are not (cf. comparative examples C3 and C4).

The yield was more than 98% of theory in all experiments

TABLE 2
PES polymerization experiments with different stirrer

| Experiment | 5 | 6 | C7 | C8 |
|---|---|---|---|---|
| Stirrer | crossed anchor | Paravisc | crossbeam/ | propeller |
| | stirrer | | flow breaker | stirrer |
| SC* | 55% | 55% | 55% | 55% |
| Determination | 7 | 7 | 7 | 13 |
| time (hours) | | | | |
| VN [ml/g] | 75 | 77 | 68 | 76 |
| Transmittance | 86 | 85 | 84 | 81 |
| [%] | | | | |
| Haze [%] | 2.5 | 2.5 | 4.5 | 7 |
| YI | 23 | 24 | 31 | 41 |

Paravisc and crossed anchor stirrer are positively conveying stirrers passing close to the wall (cf. examples 5 and 6) and the others are not (cf. comparative examples C7 and C8).

The yield was more than 98% of theory in all experiments

1. A process for the preparation of polysulfones having a yellowness index according to DIN 6167 of less than 19 and polyether sulfones having a yellowness index according to DIN 6167 of less than 30, wherein the polymerization is carried out in basic, aprotic solvents with the use of a positively conveying stirrer having d/D>0.9 and passing close to the wall.

2. (canceled)

3. The process according to claim 1, wherein the solvent used is NMP, NEP, sulfolane, DMF, DMAC and/or DMSO.

4. The process according to claim 1, wherein the stirrer used is an anchor stirrer having a flow.

5. The process according to claim 3, wherein a crossed anchor stirrer is used.

6. The process according to claim 1, wherein the stirrer used is a Seba stirrer.

7. The process according to 1, wherein the transmittance according to ASTM D 1003 is greater than or equal to 85%.

8. The process according to 1, wherein the haze according to ASTM D 1003 is less than 3%.

9. (canceled)

10. (canceled)

11. The process according to 2, wherein the transmittance according to ASTM D 1003 is greater than or equal to 85%.

12. The process according to 3, wherein the transmittance according to ASTM D 1003 is greater than or equal to 85%.

13. The process according to 4, wherein the transmittance according to ASTM D 1003 is greater than or equal to 85%.

14. The process according to 2, wherein the haze according to ASTM D 1003 is less than 3%.

15. The process according to 3, wherein the haze according to ASTM D 1003 is less than 3%.

16. The process according to 4, wherein the haze according to ASTM D 1003 is less than 3%.

17. The process according to 5, wherein the haze according to ASTM D 1003 is less than 3%.
